(19) United States
(12) Patent Application Publication
(10) Pub. No.: US 2008/0134777 A1
(43) Pub. Date: Jun. 12, 2008

(54) Single threshold liquid level sensor

(76) Inventor: Josef Maatuk, Los Angeles, CA (US)

Correspondence Address: JOSEF MAATUK, 1607 S. SHERBOURNE DR., LOS ANGELES, CA, 90035, US

(21) Appl. No.: 11/637,362

(22) Filed: Dec. 12, 2006

(51) Int. Cl. G01F 23/00

(52) U.S. Cl. 73/295

(57) ABSTRACT

An improved single threshold liquid level sensor is disclosed which provides a signal to indicate a level of liquid within a container. The sensor uses a small amount of power, has low-weight, utilizes small space and utilizes a single hot and cold thermocouple junctions being spaced along a line extending either in the direction in which the liquid level may vary or in the perpendicular direction in which the liquid may move.

### REFERENCE CITED

### U.S. Patent Documents

| | | | |
|---|---|---|---|
| 6973828 | December 2005 | Zimmermann et al. | 073/295 |
| 3145567 | August 1964 | Bobrowsky | 073/295 |
| 3901079 | August 2975 | Vogel | 073/304 C |
| 4590797 | May 1986 | Beaubatie et al | 073/295 |
| 4603580 | August 1986 | Waring | 073/295 |
| 4641523 | February 1987 | Andersson | 073/313 |
| 5201223 | April 1993 | McQueen | 073/295 |
| 5226313 | July 1993 | Murata et a.l | 073/149 |
| 5605656 | February 1997 | Sasano | 264/1.1 |
| 5626053 | May 1997 | Williamson | 073/304 R |
| 5627523 | May 1997 | Besprozvanny et al. | 340/623 |
| 5,719332 | February 1998 | wallrafen | 073/295 |

### BACKGROUND AND SUMMARY OF THE INVENTION

The present invention relates generally to devices used to measure the single threshold liquid level within a vessel or container.

There are many applications in which it is desirable to monitor the single threshold level of a liquid within a vessel. Such applications include monitoring fuel level at the bottom of a fuel tank in a motorcycle, a boat or a washing machine. In these applications it is desirable that the device be capable of providing a reliable accurate indication of the single threshold liquid level over an extended period of time without requiring periodic maintenance.

Various types of devices have been developed over the years for sensing such single threshold level of liquids. Such devices include the float type, electrical capacitors as well as thermocouple based sensors. While operable, these various types of sensors have had limitations depending upon the particular application such as the requirements for high electrical power, large space, high cost manufacturing, complexity of circuitry required to generate an indicating signal of a single threshold liquid level, susceptibility to errors from extended or extraneous electrical noise etc.

The present invention overcomes those limitations inherent in the prior art sensors, by providing an extremely reliable sensor which is light weight, takes a small space and is simple in design, uses low-power and can be manufactured at very low cost. Further, the present invention can be encapsulated or coated with a variety of suitable material to enable it to maintain prolonged operation in numerous different and potentially hostile environments. The sensor of the present invention consists of a single hot and cold thermocouple junctions arranged along a substrate with a suitable discrete resistors acting as heaters, arranged in close proximity thereto. The sensor of the present invention is a single threshold level sensor including a first thermocouple junction having a suitable heater arranged in close proximity thereto. A second thermocouple junction is interconnected with the first thermocouple junction and is literally spaced therefrom in order to compensate for a uniform ambient temperature. The first thermocouple junction provides an indication of the rate of heat dissipation by convection which is directly related to the nature of the fluid surrounding the heater and the first thermocouple junction while the second thermocouple junction provides a compensation factor dependent on the ambient temperature. This arrangement similarly provides a simple and reliable device for measurement of liquid levels within a container while minimizing the number of leads that extend through the wall of the container.

The thermocouple junctions with the connecting wires make the first electric circuit. The two discrete resistors heaters with the connecting power supply circuit make the second electric circuit. The third circuit is the signal conditioning circuit made of an amplifier and filters.

Additional advantages and features of the present invention will become apparent from the subsequent description and the appended claims taken in conjunction with the accompanying drawings.

### BRIEF DESCRIPTION OF THE DRAWINGS

FIG. 1 is a three dimensional view of the sensor of the present invention made of a thin flexible substrate connected to a rigid substrate.

FIG. 2 is a three dimensional view of the flexible substrate with the heaters

FIG. 3 is a planar view of the support and the first protective shield for the sensor in FIG. 1

FIG. 4 is a planar view of the support and the second protective shield for the sensor in FIG. 1

FIG. 5 is a planar view of the support and the third protective shield for the sensor in FIG. 1

### DESCRIPTION OF THE PREFERRED EMBODIMENTS

The liquid level of the present invention is a single threshold level sensor. It may be operable to determine the presence of liquid in a threshold level in virtually any vessel.

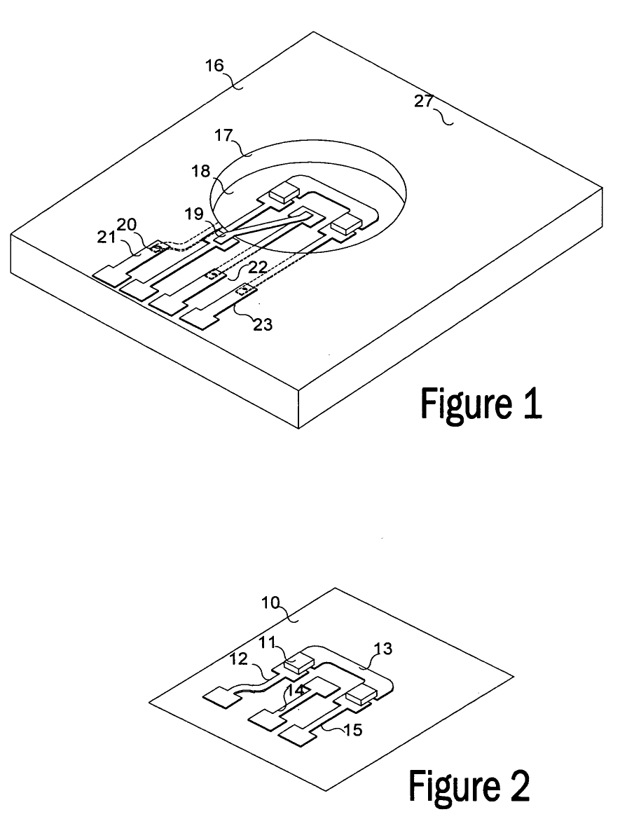

Referring now to drawings and in particular the first embodiment shown in FIGS. 1, 2 and 3, the Single threshold level sensor 11 in FIG. 1 includes a rigid substrate 10 and a flexible substrate 27. The rigid substrate has a hole 12 at its center. The rigid substrate may be fabricated from a variety of different materials but will preferably be made from a suitable printed circuit board material having good electrical insulating properties and preferably resistance to degradation from the environment in which it will be utilized. The flexible substrate may be fabricated from a variety of different materials but will preferably be made from a suitable printed circuit board material having good electrical insulating properties and preferably resistance to degradation from the environment in which it will be utilized. It is also preferable that the material for the flexible substrate be relatively thin to promote heat transfer through the flexible substrate from one surface to the other, and to promote a faster response time.

The rigid substrate 10 of the single threshold level sensor 11 includes four Copper traces, 18, 19, 21 and 22 on its top side. It also has three current conductive pins 17 on it. The bottom side of the rigid substrate has no Copper traces. The thin flexible substrate 27 in FIG. 2 has three Copper traces, 31, 31 and 32, on its top side. On the top side of the flexible substrate, two identical heating resistors 28 will be mounted. Those two resistors will act as heaters and are connected serially by Copper trace 29. From a power source like a battery, the power source is electrically connected to the contact points 26 and 23 on the rigid substrate. The power is supplied to the heating resistors through leads 18 on the rigid substrate, conducting pin 17 on the rigid substrate, lead 30 on the flexible substrate, lead 29 and lead 32 on the flexible substrate.

The single threshold liquid level sensor 11 further includes a hot thermocouple junction 16, comprising the juncture between a first copper lead 31 on the flexible substrate and a Constantan lead 15. Constantan lead 15 extend across the hole 12 to a point where it is joined to a second Copper lead 19 to thereby form a cold thermocouple junction 14 as best shown in FIG. 1. It should be understood that the first Copper lead 31 on the flexible substrate is connected electrically through a conductive pin on the rigid substrate to lead 20 on the rigid substrate which is connected to contact point 24 on the rigid substrate. The Copper lead 19 on the rigid substrate is connected electrically to the contact point 25 on the rigid substrate. The first lead 24 and the second lead 25 are operable to transmit a signal from the hot and cold thermocouple junctions 16 and 14 to an external signal conditioning circuit which includes an amplifier and filters will be connected to the contact points 25 and 24 on the rigid substrate. Specifically, as signals are transmitted from the hot and cold thermocouple junctions 16 and 14 to contacts 24 and 25 via leads 31 and 21 and pin 17 for contact point 24 and lead 19 for contact point 25, the signals are received by the external signal conditioning circuitry. It should be understood that any suitable signal conditioning circuitry for amplifying and filtering the signals received from the hot and cold junctions 16 and 14 are anticipated and should be considered as part of the present invention.

The top side of the flexible substrate 27 will be attached to the bottom side of the rigid substrate 11 with a sealing adhesive. The hole 12 of the rigid substrate will be filled with a foam that will keep the flexible substrate from flapping and acting as a membrane. The foam can be a closed cell foam. The top of the rigid substrate 11 can also be coated to protect the metal lead. It can also be sealed with epoxy or another suitable material. The coating will not cover the contact points 23, 24, 25 and 26.

In operation, the hot thermocouple junction 16 will generate a potential, the magnitude of which will be dependent upon its temperature. Assuming a sensor such as is shown in FIGS. 1 and 2, the total voltage generated when the probe is not immersed in liquid will be the potential generated by the heated hot thermocouple junction 16 minus the voltage generated by the unheated cold junction 14. However, if the hot thermocouple junction 16 is immersed in a liquid, the greater thermal transfer efficiency afforded by liquids as opposed to gaseous fluids will result in reduced heating of the immersed hot thermocouple junction 16 by the heating resistors 28 and hence a lower potential being generated thereby. The amount of heat transferred to the hot thermocouple junction 16 and hence the potential it may generate, is also influenced by ambient temperatures. In this manner, it is necessary to provide the cold thermocouple junction 14 in electrical communication with the hot thermocouple junction 16. The orientation between the dissimilar metals of the Copper and Constantan leads for cold thermocouple junction 14 is reversed from that of the hot thermocouple junction 16. This result in the cold thermocouple 14 generating a potential of opposite polarity to that of the hot thermocouple junction 16. Thus, because the cold thermocouple junction 14 is connected in series with the hot thermocouple junction 16, this opposite polarity potential will subtract from the potential generated by the hot thermocouple junction 16. The value of the cold thermocouple junction 14 potential will be less than the potential produced by the hot thermocouple junction 16 because the heating resistors 28 maintain the hot thermocouple junction 16 at a temperature above ambient. Thus, as may be appreciated, the potential produced by the hot and cold thermocouple junctions 16 and 14 will produce a resulting potential which is indicative of whether or not the single threshold level sensor is immersed in a liquid.

As mentioned previously, the resulting signal produced by the thermocouple junctions 16 and 14 is supplied to an external signal conditioning circuitry via the contact points 24 and 25. The external signal conditioning circuitry is operable to amplify the thermocouple junctions output signal and includes suitable filters to reduce electrical bias, drift and random noise or the like. The resulting signal from the external signal conditioning circuitry is indicative of the fluid level and maybe supplied to suitable remote indicating means for monitoring of the liquid level as sensed by the sensor 11.

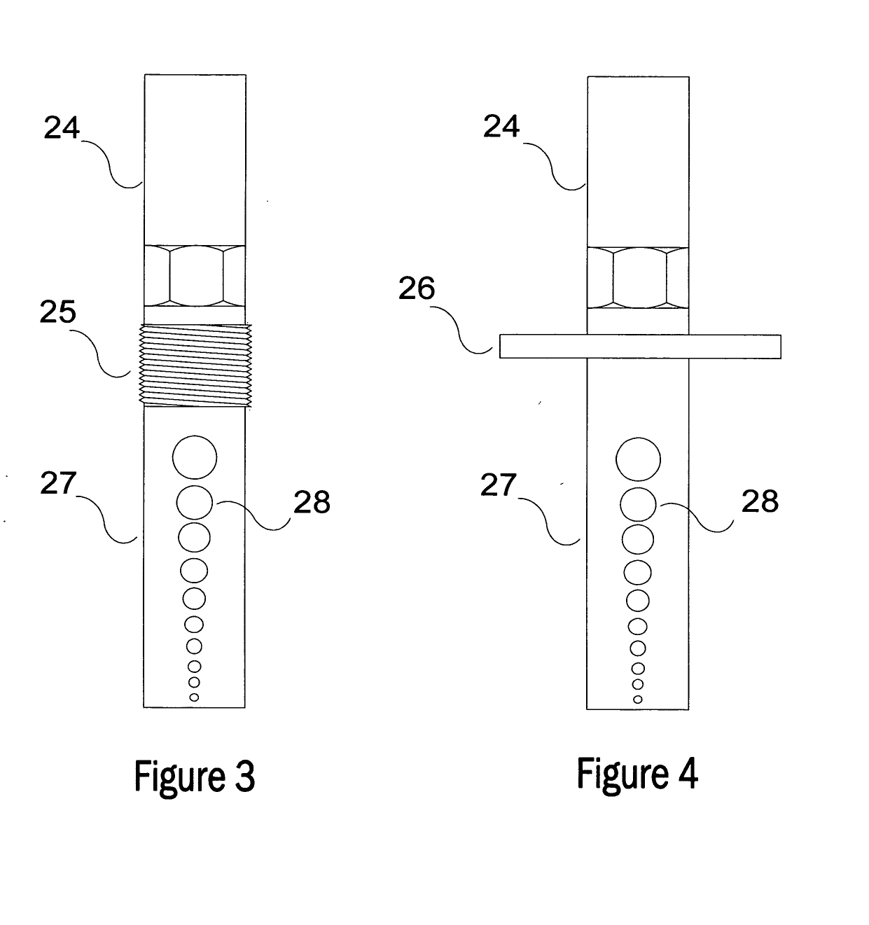

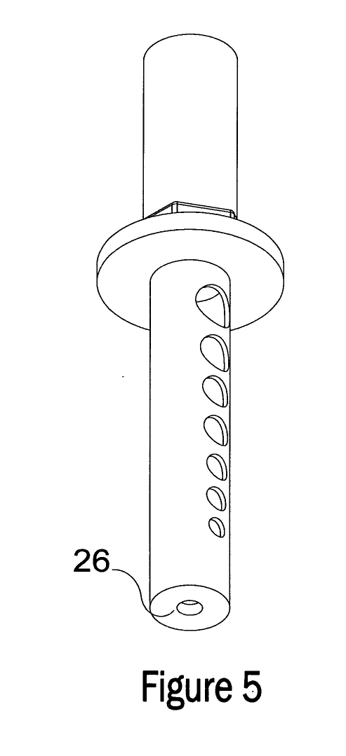

As shown in FIGS. 3, 4 and 5, a cylindrical tube can generally be used to house the sensor 11 inside it as well as to provide a protective shield for the sensor. In the bottom portion of the tube, the heaters and the thermocouple junctions will be mounted. In the top portion of the tube, the signal conditioning and the power source circuitry will be located. In FIG. 3 the bottom portion of the tube starts at the bottom of the threaded section or the flanged section of FIGS. 4 and 5. This bottom section of the tube must contain the heaters and the thermocouple junctions. The remaining parts of the sensor 11 and the signal conditioning circuitry and power source circuitry can all be located in the top portion of the tube. After the mounting of the sensor 11 inside the tube, the top and bottom section of the tube can be separated by using a sealant such an epoxy to separate the sensor 11 sections that are in the bottom of the tube from the sections that are in the top of the tube. In FIG. 3, the bottom of the tube has plurality of bores to control the flow into and out of the bores during sloshing. To achieve a desired constant in and out flow from the bores regardless of the height of the liquid in the container, the bores need to be designed with properly selected variable diameters. In FIG. 5, there is a single bore at the bottom. If a fixed diameter bore is selected and no side bores along the tube, then during sloshing, for different height of liquid, the rate of the in and out flow from the bottom bore will not be at a desired constant rate.

While it will be appreciated that the preferred embodiment of the invention disclosed are well calculated to provide the advantages and features above stated, it will be appreciated that the invention is susceptible to modification, variation and change without departing from the proper scope or fair meaning of the subjoined claims.

1. A liquid level sensor assembly comprising:
A first electric circuit comprising a first thermocouple junction and a second thermocouple junction, said second thermocouple junction located in a spaced relationship from said first thermocouple junction along a first axis;
a second electric circuit comprising a heat source in thermal communication with said first thermocouple junction;
a housing;
an electric feed-through located at one end of said housing, said electrical feed-through comprising a plurality of current conducting pins;
a third electric circuit and said second electric circuit each electrically connected to at least one of said pins on one side of said electrical feed-through and said third electric circuit electrically connected to at least one of said pins on an opposite side of said electrical feed-through.

2. An assembly as set forth in claim 1, wherein said assembly is adapted to be disposed within a vessel containing a volume of fluid defining a fluid level such that said first axis is generally parallel with said fluid level.

3. An assembly as set forth in claim 1 further comprising a shield attached to and extending from said housing and covering said first electric circuit and said second electric circuit.

4. An assembly as set forth in claim 3 wherein said shield includes a plurality of apertures.

5. An assembly as set forth in claim 1, wherein said housing comprises a male threaded portion.

6. An assembly as set forth in claim 5, wherein said housing comprises a plurality of flats for engaging a tool.

7. An assembly as set forth in claim 6, wherein said assembly is adapted to be disposed within a vessel containing a volume of fluid defining a fluid level such that said first axis is generally parallel with said fluid level.

8. A liquid level sensor assembly comprising
a substrate having a first axis;
a first thermocouple junction disposed on said substrate;
a second thermocouple junction disposed on said substrate in a spaced relationship along said first axis relative to said first thermocouple junction, said second thermocouple junction being in electrical series with said first thermocouple junction;
a heat source in thermal communication with said first thermocouple junction;
a housing comprising an electrical feed-through disposed at one end, said electrical feed-through comprising at least one current conducting pin extending from an interior of said housing to an exterior of said housing and wherein
said first and second thermocouple junctions are electrically connected to said at least one current conducting pin on one side of said electrical feed-through.

9. An assembly as set forth in claim 8, wherein said assembly is adapted to be disposed within a vessel containing a volume of fluid defining a fluid level such that said first axis is generally parallel with said fluid level.

10. An assembly as set forth in claim 8 further comprising a shield attached to and extending from said housing and covering said first and second thermocouple junctions.

11. An assembly as set forth in claim 10, wherein said shield includes a plurality of apertures.

12. An assembly as set forth in claim 8, wherein said housing further comprises a male threaded portion.

13. An assembly as set forth in claim 12, wherein said housing further comprises a plurality of flats for engaging a tool.

14. An assembly as set forth in claim 13, wherein said assembly is adapted to be disposed within a vessel containing a volume of fluid defining a fluid level such that said first axis is generally parallel with said fluid level.
